(19) United States
(12) Patent Application Publication
(10) Pub. No.: US 2012/0031248 A1
(43) Pub. Date: Feb. 9, 2012

(54) PULL-ROD LOCKING DEVICE FOR A MITER SAW

(75) Inventors: Keith Park, York (GB); Kesong Xu, Ningbo (CN)

(73) Assignee: CHERVON (HK) LIMITED, Wanchai (HK)

(21) Appl. No.: 13/195,136

(22) Filed: Aug. 1, 2011

(30) Foreign Application Priority Data
Aug. 3, 2010 (CN) 201020280045.6

(51) Int. Cl. B23D 47/00

(52) U.S. Cl. 83/471.2

(57) ABSTRACT

An operating element of a locking device is used to switch a locking element into and out of engagement with a pull rod of a miter saw to respectively lock and unlock moveability of the pull rod.

### RELATED APPLICATION DATA

This application claims the benefit of CN 201020280045.6, filed Aug. 3, 2010, the disclosure of which is incorporated herein by reference in its entirety.

### BACKGROUND

The subject disclosure generally relates to a pull-rod type miter saw.

The pull rod in a miter saw of the type having a slide cutting function generally needs to be locked during packaging, transmitting, and conveying. The pull rod is usually locked by means of screw thread, which is simple, economic, and widely used in the industry. This common locking device takes the form of a knob and screw in appearance. An operator may rotate the knob for locking until the head of the screw bears against the circular surface of the pull rod. The pull rod is thereby locked by means of the pressing force exerted on the pull rod by the screw, namely, by the large static friction force between the pull rod and the screw.

However, locking the pull rod with a common knob and screw has the following defects:

1. It seems to be cheap in appearance;

2. The operator needs to rotate the device several cycles to lock the pull rod, thus the operation of the device is not convenient; and

3. The locking force, which is dependent upon the working experience of the operator, will destroy the surface of the pull rod if the force is too large and locking of the pull rod can not be achieved if the force is too small.

### SUMMARY

The following describes a pull-rod locking device for a miter saw which overcomes the disadvantages noted above. To this end, the pull-rod locking device comprises a locking element for locking the pull rod and an operation part or handle for manual operation thereof. The pull-rod locking device is movable between a locking position and a releasing position with respect to the pull rod. Switching between the locking position and the releasing position is achieved by adjusting the operation part in a certain manner. In the locking position, the locking element will be placed into contact with the pull rod and, in the releasing position, the locking element will be distanced from the pull rod by a predetermined distance. In certain embodiments, the pull-rod locking device will engage with at least one locating structure on the miter saw to maintain the pull-rod locking device in a locking state or a releasing state. The pull-rod locking device for the miter saw described hereinafter thus has a simple structure, can ensure efficient locking of the pull-rod with an even force, will not damage the face of the pull rod, and has a relatively more pleasing visual effect.

### BRIEF DESCRIPTION OF THE DRAWINGS

The subject device will be described with reference to the following drawings wherein:

FIG. 1 is a side view of an exemplary pull-rod miter saw machine constructed according to the description that follows;

FIG. 2A is a schematic view illustrating that the pull-rod locking handle of the miter saw of FIG. 1 as placed into a locking state;

FIG. 2B is a schematic view illustrating the pull-rod locking handle of the miter saw of FIG. 1 as placed into a releasing state;

FIG. 3 is a sectional view of the pull-rod locking device of the miter saw of FIG. 1; and

FIG. 4 is an exploded view of the pull-rod locking device of the miter saw of FIG. 1.

### DETAILED DESCRIPTION

The following describes a pull-rod locking device used in a pull rod type miter saw or other similar machines. The pull-rod locking device is mounted on one side of the pull rod, and comprises a locking element for locking the pull rod and an operation part for manual operation. By operating the operation part, the pull-rod locking device may be switched between a locking position and a releasing position. Specifically, in the locking position, the pull-rod locking device interferes with the pull rod directly or indirectly by acting on the pull rod or another trapping device, thereby preventing the pull rod from sliding with respect to the saw body of the miter saw. In the releasing position, the pull-rod locking device is not in interference with the pull rod, thus the pull rod can slide with respect to the saw body of the miter saw, thereby performing some functional operation such as a cutting. The pull-rod locking device may be switched between the releasing position and the locking position by an adjustment in a substantially constant range, and such an adjustment is visible and convenient.

Referring to FIG. 1, illustrated is a pull rod type miter saw 1 according to one preferred embodiment. As illustrated, the miter saw 1 includes a cutting head 11 and a slide brace assembly 17. When the cutting head 11 is in a horizontal cutting position, it can slide back and forth along the pull rod 171 with the aid of the linear bearing 151 on the rocker arm assembly 15, so that a cutting of the object (not shown) positioned on the platform 12 can be achieved. The pull-rod locking handle assembly 16 is installed on one side of the pull rod 171 for locking the slide brace assembly 17 in the case of packaging, transittings, and conveyance, so that damages to the miter saw 1 due to accidental relative sliding can be avoided. The pull-rod locking handle assembly 16, being installed on one side of the pull rod 171, need not be limited to any specific position such as left, right, top or bottom, but may be installed in any position that allows the pull-rod locking handle assembly 16 to release or lock the pull rod 171 simply.

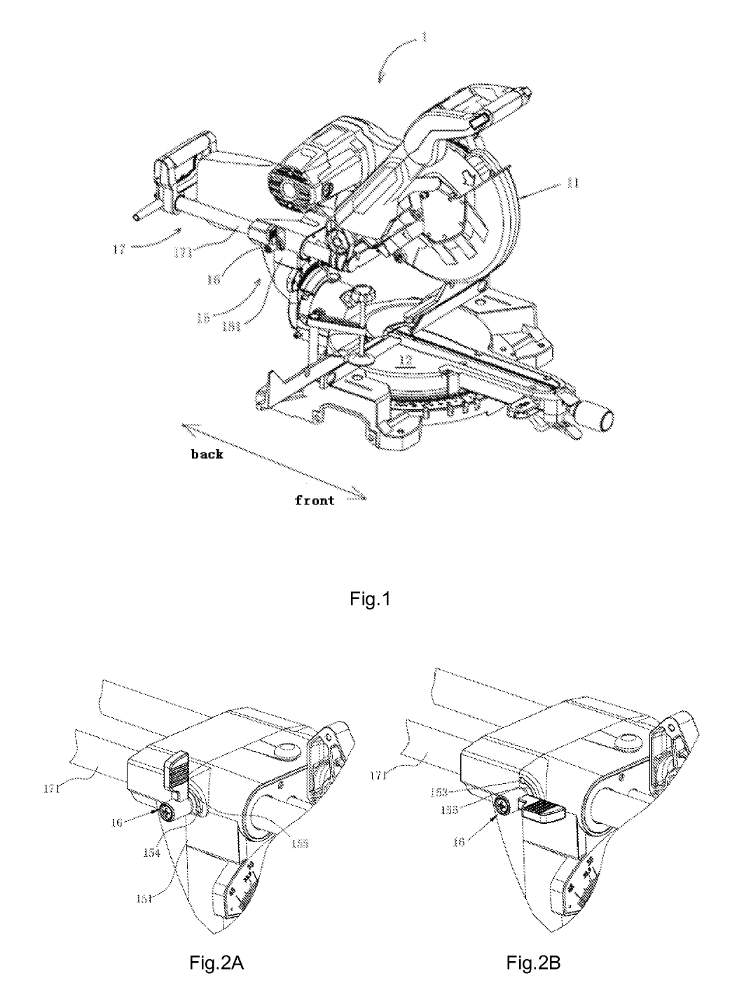

Referring to FIGS. 2A and 2B, the pull-rod locking handle assembly 16 has two functions: locking and releasing. In the state of locking, the pull-rod locking device is in a locking position where the pull rod is fixed and cannot move; the state of releasing is relative to the state of locking, and in this state, the pull-rod locking device is in a releasing position where the pull rod can move freely. In the present embodiment, the pull-rod locking device can be switched between the locking and releasing states by rotating the assembly 16 a fixed angular amount. In this way, a visible and convenient operation indication is provided for operators.

The rocker arm 151 of the miter saw 1 is formed with two recesses 153 and 154 thereon which correspond to the locking position and the releasing position respectively. A locating element is provided on the pull-rod locking handle assembly 16, which can elastically engage with the recesses 153 and 154 for locating the pull rod 171 and for indicating the present state thereof when locking or releasing the pull rod 171. Preferably, a guiding groove 155 is formed between the two recesses 153 and 154 to facilitate the sliding of the locating element between the two recesses. When the locating element is slid from the guiding groove 155 to the recess 153 or 154, a loud noise may be produced so that the operator is reminded that the pull rod 171 has been released or locked.

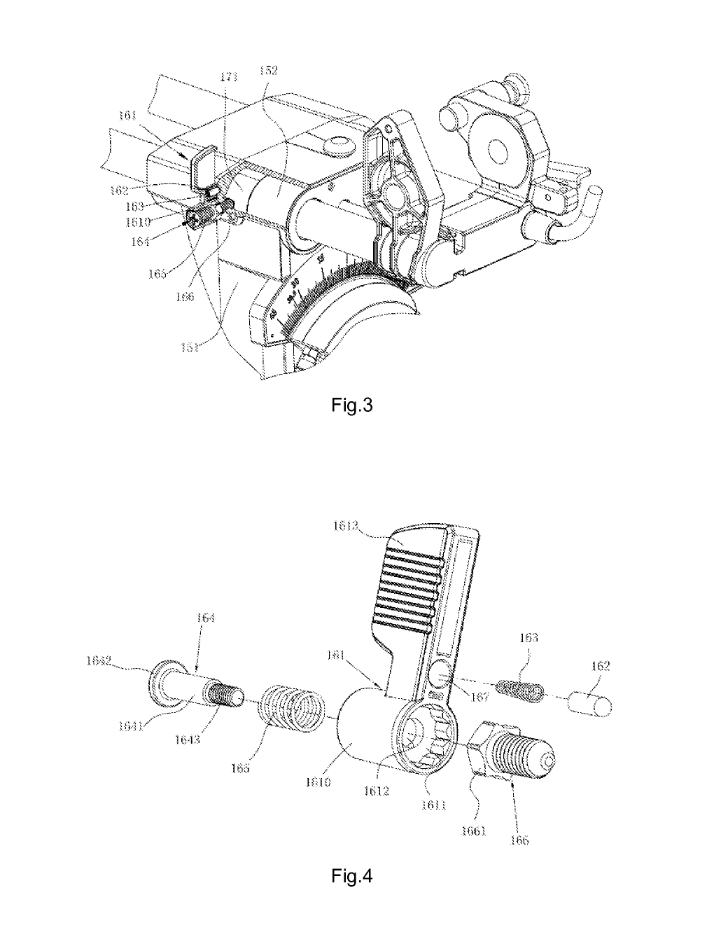

Referring to FIGS. 3 and 4, the pull-rod locking handle assembly 16 includes a locking element and a handle assembly 16 mounted on the locking element and operated manually by the users of the miter saw. In the present embodiment, the locking element takes the form of a screw 166 mounted to one side of the pull rod 171 by passing through a threaded hole (not shown) in the linear bearing 152. By screwing in and out of the threaded hole, the screw can move inwards to abut against the surface of the pull rod 171 for locking or move outwards to disengage from the pull rod 171 for releasing. In the present embodiment, it is configured such that the locking position and the releasing position can be switched between by rotating the screw 166 through 90 degrees. In this way, the guiding groove 155 is correspondingly formed in the shape of one quarter of a circle. Certainly, depending on the specific circumstances, other arc length ranges are also possible for achieving the switching of the positions. Once the initial position between the locking screw and the pull rod is adjusted, for the locking or releasing operation each time, as long as the screw 166 is rotated in a certain arc range about its centre line to move towards or away from the pull rod for a substantially constant distance, locking or releasing of the pull rod may be achieved, which is very convenient for the operator. In the locking position, the screw 166 closely contact the pull rod towards the surface of the locked pull rod; and in the released position, the screw 166 is distanced from the pull rod by a predetermined distance towards the surface of the locked pull rod. In other embodiments, the locking element may further have a soft surface arranged on the end of the screw 166 facing the locked pull rod so as to get a better close contact with the pull rod in the locking position and further protect the surface of the pull rod. In other embodiments, the locking element may be other elements in other forms and structures.

In the present embodiment, the locating element of the pull-rod locking handle assembly 16 may take the form of a positioning pin 162. The positioning pin 162 is arranged in a mounting hole 167 on the handle assembly or lever 161. A first spring 163 is arranged in the mounting hole 167, which can elastically bears against the positioning pin 162 outwards so that the positioning pin 162 can slide smoothly between the two recesses and the guiding groove. The positioning pin 162 may be assembled in the mounting hole 167 by means of its enlarged head portion (not shown) or a fixing element so as to prevent it from disengaging from the mounting hole 167.

It should be noted that, the locating recesses are provided for locating the positioning pin 162 in a stable state when it is in the releasing and locking positions, that is to say, the positioning pin 162 will not move away from the locking position automatically due to shaking to affect conveyance safety, or move away from the releasing position automatically and interfere with the pull rod to affect the normal cutting. This relative stable state may be achieved in other ways, for example, by providing a clamping groove, a magnet attracting components or an additional fixing element, which may have the same effect to some degree.

Certainly, if the applications of the miter saw is relative stable, that is to say, if it is not necessary to worry about in these applications that the pull-rod locking handle assembly 16 may automatically disengage from the locking or releasing position due to shake or collision, the locking element of the locking handle assembly 17 may be omitted to make the structure more compact. However, in this case, an indicating marker is preferably provided for indicating the locking or releasing position to the operator. The marker may be indication character or pattern marked in the surface of the miter saw, meanwhile, an indicating line (not shown) would be arranged in the pull-rod locking handle 16, which aligns with the indicating marker for indicating the releasing state or the releasing state. The combination of the indicating line and the indicating maker can be applied in the practice with the recesses or the like simultaneously.

When the pull-rod locking handle assembly 16 is screwed into the threaded hole, it is possible that the locking handle 161 after screwing may be random in orientation, that is to say, in the locking and releasing positions, it is most likely that the positioning pin 162 is not accommodated in the locating recesses 153 and 154, or the handle assembly 16 is not aligned with the indicating marker of the miter saw. To resolve this problem, a clutch structure is arranged between the pull-rod locking handle 161 and the screw 166.

This clutch structure may be embodied by an inner toothed hole 1611 on the locking handle 161 and a polygonal head 1661 on the screw 166. The inner toothed hole 1611 is formed in one end of the assembling portion 1610 of the pull-rod locking handle 161, within which the polygonal head 1661 is accommodated. Due to the design of the polygonal and inner toothed hole, the polygonal head 1661 may be accommodated in the inner toothed hole 1661 again after the screw 166 and the handle 161 is rotated by a certain angular amount (for example, 30 degrees). This angle by which the screw 166 and the handle 161 is rotated to enable the polygonal head 1661 to be accommodated again in the inner toothed hole 1611 may be determined by the number of the sides of the polygonal head 1661 as well as the inner toothed hole 1611. Once the polygonal head 1661 enters into the inner toothed hole 1611, the two are engaged with each other and cannot move relatively, then a certain torque can be transmitted between the polygonal head 1661 and the locking handle 161.

It can be known from the above that, if the locking position of the screw 166 is not aligned with the position of the positioning pin 162 in the recess 153, the locking handle 161 may be disengaged from the screw 166, and rotated by an angle, and then engaged again, as a result, the screw is switched from one accommodated state to another accommodated state with respect to the locking handle 161, the locking position of the positioning pin 162 is then adjusted.

In order to facilitate the adjustment of the locking position, a stopping element is arranged in the locking handle 161. As shown in FIG. 4, the stopping element is a stepped screw 164, which includes a body portion 1641, a stopping portion 1642 with a larger section at one end thereof, and a threaded portion 1643 with a smaller section at the other end thereof. A through hole 1612 is formed on the tip of the inner toothed hole 1611, through which the stepped screw 164 extends into the inner toothed hole 1611 and engages with the screw 166 with its threaded portion 1643. The body portion 1641 may slide axially in the through hole 1612 and the stopping portion 1642 cannot pass through the through hole 1612. Preferably, the stepped screw 164 and the screw 166 are concentric with each other. When the locking position needs to be adjusted, the locking handle 161 may be disengaged from the screw 166, by this time, in the presence of the stepped screw 164, the locking handle 161 may not be disengaged from the screw 166 as a locking element, but moves back and forth along the centre line of the stepped screw 164 and the screw 166 and is restricted between the stopping portion 1642 and the screw 166. In the locking or releasing operation, the locking handle 161 may be rotated about the centre line so as to facilitate the operation of the user.

Preferably, a spring element is provided in the locking handle 161, which is a second spring 165 surrounding the body portion 1641. With the spring force of the second spring 165, the locking handle 161 can be provided with a spring restoring force so as to tend towards the locking element all the time. When no external force is exerted to the locking handle 161, the locking handle is pressed onto the locking element, as a result, the comfort ability and convenience of the user operation may be further enhanced. As shown in FIG. 4, the locking handle 161 is also provided with a gripping portion 1613 for the user exerting a force by finger, which further facilitates the user operation. The gripping portion 1613 may be used for indicating the locking state and the releasing state in combination with an indicating maker provided upon the miter saw 1.

In order to obtain a good locking effect, the screw 166 may have a larger screw thread or double-start thread to increase the pitch of the screw thread.

It should be noted that, in the present embodiment, the locking screw is selected as an device to directly contact the pull rod of the miter saw. However, other fittings, as long as they can obtain the same object, that is to say, as long as they can obtain the effect of approaching and locking and disengaging and releasing the pull rod by the switch between the two positions, may be used in other embodiments of the present invention.

In addition, as the embodiment of the pull-rod locking device of the present invention, the pull-rod locking handle assembly 16 takes the form of an “assembly” including a locking handle 161 and a screw 166 engaged with each other. It can be seen from the description that it is not necessary for the present invention to use a separated structure, and a one-piece structure may also be possible.

The above contents disclose preferred embodiments of the present invention which are not to be used to limit the scope of the present invention. Rather, any technical solutions obtained by equivalent replacements or changes will be regarded as part of the scope of this invention.

What is claimed is:

1. A locking device for a miter saw having a pull-rod, comprising:
a locking element; and
an operating lever coupled to the locking element, the operating lever being moveable between a locking position and a releasing position over a predetermined range whereby the locking element is switched between a position of engagement with and disengagement with the pull-rod of the miter saw, respectively.

2. The locking device according to claim 1, wherein in the locking position an end face of the locking element directly contacts the pull rod and in the releasing position the end face of the locking element is spaced from the pull rod a predetermined distance.

3. The locking device according to claim 2, further comprising a locating element associated with the operating lever, the locating element cooperating with at least one locating structure on the miter saw to keep the operating lever in one of the locking state and the releasing state.

4. The locking device according to claim 3, wherein the locating element is arranged in a mounting hole on the operating lever and flexibly extends out of the mounting hole for engagement with the locating structure.

5. The locking device according to claim 4, wherein the locating structure comprises two locating recesses and wherein the positioning element is engageable with one of the two locating recesses in a respective one of the locking state and the releasing state.

6. The locking device according to claim 5, comprising a guiding groove formed between the two locating recesses for guiding the positioning element between the two locating recesses.

7. The locking device according to claim 1, wherein the operating lever comprises an handle extending from an assembling portion having a hole in which the locking element is arranged.

8. The locking device according to claim 7, wherein the assembling portion is formed with a toothed hole and the locking element has a polygonal head which is at least partially accommodated within the toothed hole.

9. The locking device according to claim 8, wherein a stopping element is arranged on one end of the toothed hole opposite to the locking element and the stopping element is coupled to the locking element so that the locking element is movable in a axial direction in the toothed hole and at least allows for the polygonal head of the locking element to disengage from the toothed hole.

10. The locking device according to claim 9, wherein the stopping element comprises a screw screwed into an end of the locking element.

11. The locking device according to claim 9, wherein the stopping element is connected to the locking element by passing through a through hole formed in the operating lever, wherein the stopping element has a stopping portion which is engaged with one side of the through hole opposite to the locking element, and wherein a spring element is arranged between the stopping portion and the through hole.

12. The locking device according to claim 1, wherein the locking element is a double-thread screw positioned in a threaded hole of a mounting assembly positioned on one side of the pull rod.

13. The locking device according to claim 1, wherein a marking line is provided on the miter saw for indicating the locking state and the releasing state in cooperation with an indicating sign provided on the locking device.
